(19) United States
(12) Patent Application Publication
(10) Pub. No.: US 2015/0187115 A1
(43) Pub. Date: Jul. 2, 2015

(54) DYNAMICALLY ADJUSTABLE 3D GOGGLES

(71) Applicants: Mark A. MacDonald, Beaverton, OR (US); David W. Browning, Beaverton, OR (US)

(72) Inventors: Mark A. MacDonald, Beaverton, OR (US); David W. Browning, Beaverton, OR (US)

(21) Appl. No.: 14/142,579

(22) Filed: Dec. 27, 2013

(51) Int. Cl. G06T 15/00; G02B 27/01; G06F 3/01

(52) U.S. Cl. CPC G06T 15/00; G06F 3/013; G02B 27/0172; G02B 2027/0178

(57) ABSTRACT

Embodiments are generally directed to dynamically adjustable three-dimensional (3D) goggles. An embodiment of an apparatus includes a frame; a display for 3D images; and a dynamically adjustable lens assembly including one or more lenses for viewing the 3D images; wherein a focal length of the lens assembly is dynamically adjustable in response to received focal distance data.

### TECHNICAL FIELD

Embodiments described herein generally relate to the field of electronic devices and, more particularly, to dynamically adjustable 3D goggles.

### BACKGROUND

There are a number of techniques used to create 3D (three-dimensional) visualization of data or media for the viewer. At the core of each these techniques, the visualization works by presenting different images to each of the viewer's eyes.

There are also numerous different methodologies that are used to present 3D material to viewers. Common approaches to 3D imaging include technologies such as polarization filtering, color filtering, active shuttering of eyepieces, pairs of pixels with differing light emission angles, or goggles with independent screens (or portions thereof) isolated for each eye.

However, a significant number of viewers report discomfort or headaches that are induced by 3D visualizations for all of these techniques, and such visual ergonomic issues negatively impact the desirability of 3D media and 3D imaging technology. At least in part because of this problem, expansion of use of 3D imaging remains limited.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of a goggle assembly including a lens element with a fixed focal length;

FIG. 2 is an illustration of an embodiment of a goggle assembly including a lens element with an adjustable focal length;

FIG. 3 illustrates 3D goggles with dynamically adjustable lenses according to an embodiment;

FIG. 4 illustrates an embodiment of 3D goggles with dynamically adjustable lenses utilizing data including focal distance data;

FIG. 5 illustrates an embodiment of 3D goggles with dynamically adjustable lenses utilizing calculated focal distance data;

FIG. 6 illustrates an embodiment of 3D goggles with dynamically adjustable lenses utilizing calculated focal distance data and eye tracking operation;

FIG. 7 illustrates an embodiment of 3D goggles with dynamically adjustable lenses utilizing calculated focal distance data and eye tracking operation and modified visualization data;

FIG. 8 is an illustration of components of 3D goggles according to an embodiment; and

FIG. 9 is a flow chart to illustrate an embodiment of a process for 3D goggle operation.

### DETAILED DESCRIPTION

Embodiments described herein are generally directed to dynamically adjustable 3D goggles.

For the purposes of this description:

“3D goggles” or “3D glasses” means a wearable element for viewing 3D images for a person. The terms “3D goggles” or “3D glasses” are intended to include eyeglasses, goggles, and other similar external elements for viewing of 3D images.

“Virtual focal distance” means a focal distance that an observer's eye must adjust to in order to correctly resolve a projected 3D image. In the presence of lenses in a viewing system, the “virtual focal distance” may be different from the actual distance from the observer's eyes to the image plane.

“Apparent distance” means a distance at which an object in a virtual image appears to be from a viewer. Apparent distance includes a distance at which each portion of a 3D image appears to be from the viewer.

One of the primary causes for the discomfort for viewers of 3D images is created by a conflict created as an observer's brain and eyes try to reconcile differences between the virtual focal distance and the apparent focal distance. When a 3D object visualization is perceived by the viewer to get closer to the viewer, the brain of the viewer instinctively commands the eyes to start focusing more near-field, which would be required to maintain focus on a real object approaching the viewer.

However, because the image (or pair of images for 3D imagery) being used to create the 3D visualization is typically being rendered on a fixed plane, the actual required focal length for the eye does not change regardless of the perceived distance. The conflict between the instinctive desire of a viewer to change focal length of the viewer's eyes and the actual need to maintain the focal plane for the image creates eye strain, discomfort, and headaches for some viewers.

Visual ergonomics for 3D media consumption will likely become increasingly important in the coming years as more wearable and glasses-like devices and usage models are developed.

In some embodiments, an apparatus, system, and method provides for an automatic transversing or otherwise adjustable focusing element that may be used to reduce the induced eyestrain and corresponding viewer discomfort that may be generated when a viewer uses goggles or glasses type visualization of 3D rendered data.

When using goggles or image producing glasses to create the 3D visualization, the image plane is very close to the viewer's eyes. The image plane is generally too close for the eyes to focus normally on that plane. Healthy human eye minimum focal distance is ˜10 cm (centimeters). Consequently, a focusing lens assembly is conventionally used to create a virtual focal plane at a more comfortable nominal virtual distance to the eye. In a conventional 3D goggle assembly, a focusing element is a fixed focusing element, where fixed refers to the fixed nature of the focusing element that creates the virtual nominal focusing distance.

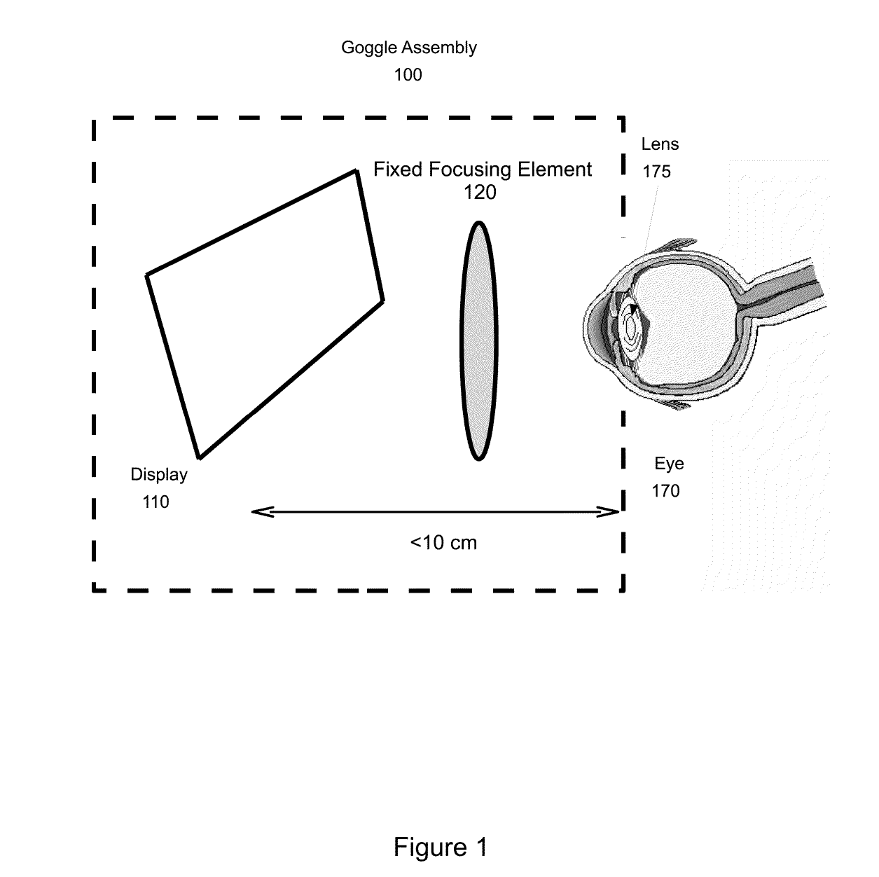

FIG. 1 is an illustration of a goggle assembly including a lens element with a fixed focal length. In this illustration, a goggle assembly 100 includes a goggle display 110 and a focusing element having a fixed focal length 120. It is noted that a fixed focusing element may be capable of providing some adjustment for a particular viewer, such as to manually or electronically move the focusing element 120 such that display appears to be in focus for the eye 170 of the viewer or to compensate for a prescription lens worn by the viewer. In general, the distance between the goggle display 110 and the eyes 170 of the viewer (illustrated with lens 175) will be less than 10 cm, and thus the focusing element 120 is necessary for the viewer to view the image 110 at a comfortable virtual distance.

However, the 3D image presented on the display 110 will contain portions that appear to be closer to the viewer, and portions that appear to farther away from the view, which generates a natural focusing response for the viewer. In particular, the 3D image may contain objects that appear to be in motion towards or away from the viewer. For this reason, the viewing of 3D using the goggle assembly 100 may cause significant discomfort for some individuals.

In some embodiments, an apparatus, system, or method provides for a focusing lens assembly with a dynamically adjustable focal length. In some embodiments, lenses of an assembly are integrated with a dynamically adjustable mechanism, allowing the distance from the eye to the virtual focal plane to be adjusted dynamically to correspond to the apparent distance that the viewer expects for the object currently being observed in the visualization.

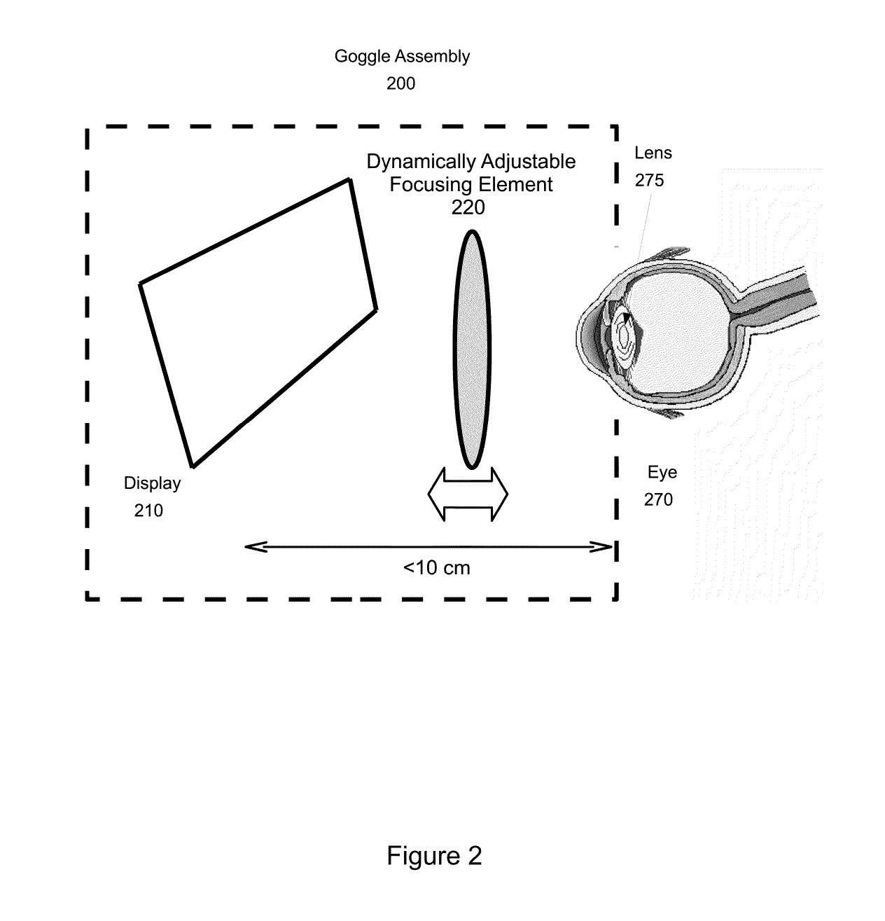

FIG. 2 is an illustration of an embodiment of a goggle assembly including a lens element with an adjustable focal length. In some embodiments, a goggle assembly 200 includes a goggle display 210 and a dynamically adjustable lens assembly 220, wherein the lens assembly includes one or more lenses and an adjustment mechanism to automatically adjust a focal length of the lens assembly. The distance between the goggle display 210 and the eyes 270 (illustrated with lens 275) of the viewer in general is less than 10 cm, and thus the lens assembly 220 is necessary for the viewer to view the image 210 at a comfortable virtual distance. In some embodiments, the lenses of the lens assembly 220 are dynamically adjustable. In some embodiments, the focal length of the lens assembly 220 is adjusted dynamically such that the virtual focal distance corresponds to the apparent distance that the viewer expects for the object currently being observed in the visualization.

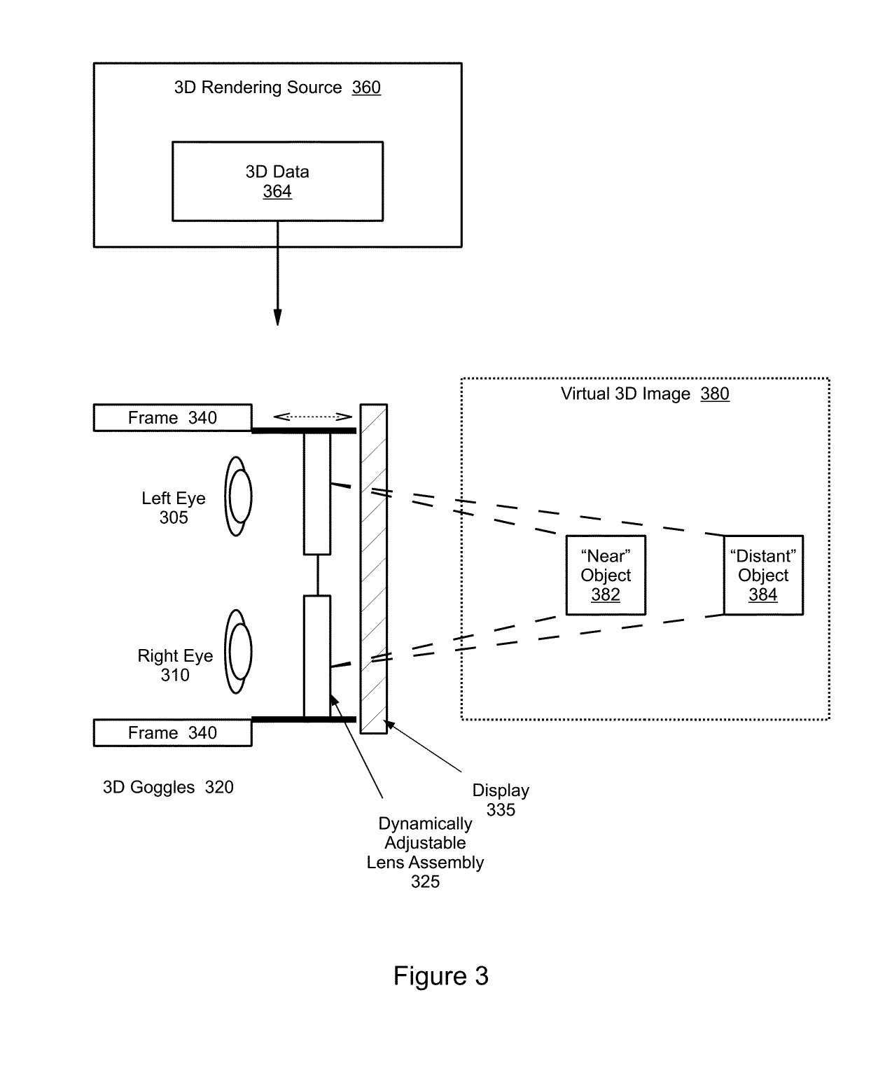

FIG. 3 illustrates 3D goggles with dynamically adjustable lenses according to an embodiment. In some embodiments, 3D goggles 320 include a dynamically adjustable lens assembly 325 that adjusts the focal length of the lens assembly used by a viewer, whose left eye 305 and right eye 310 are illustrated in FIG. 3, in the viewing of a display 335. In some embodiments, the dynamically adjustable lens assembly includes a linear motor, rotational motor, or other mechanical element to automatically adjust the focal length of the lenses of the lens assembly. In some embodiments, the lens assembly includes existing automatic focusing element technologies. The goggles 320 may further include a frame 340, which may be of any shape for wearable use by a viewer, and other elements that are not illustrated in FIG. 3. The 3D goggles 320 may receive 3D data 364, such as a 3D image, a 3D movie, or a 3D virtual reality data stream, from a data source, such as 3D rendering source 360.

As illustrated in FIG. 3, the viewer is viewing an image displayed on a display 335, but, through use of the lenses 325, the viewer sees a virtual 3D image 380 that appears to be further away from the viewer than the display 335 at a certain virtual distance. In some embodiments, the virtual 3D image contains objects that appear to the viewer to be varying distances from the viewer, such as a “distant” object 384 and a “near” object 382, where the distant object 384 appears to be farther away from the viewer than the near object 382 within the virtual 3D image 380. In some embodiments, the focal length of the dynamically adjustable lens assembly is automatically increased or decreased so that the distance of the virtual focal plane appears to change in a natural way for the eyes 305-310 of the viewer.

The 3D goggles 320 may include certain elements that are not illustrated in FIG. 3 that may be required for operation, including a battery; a charger input or a wireless power receiver if the battery is a rechargeable battery; and an on-off switch to enable and disable the goggles, which may, for example be a switch that automatically turns on when the goggles are put on.

Embodiments may vary in terms of, for example, implementation of the 3D distance data generation and presentation, wherein implementations may vary in terms of complexity and naturalness of the viewer's perceptions of the visualization. Embodiments include:

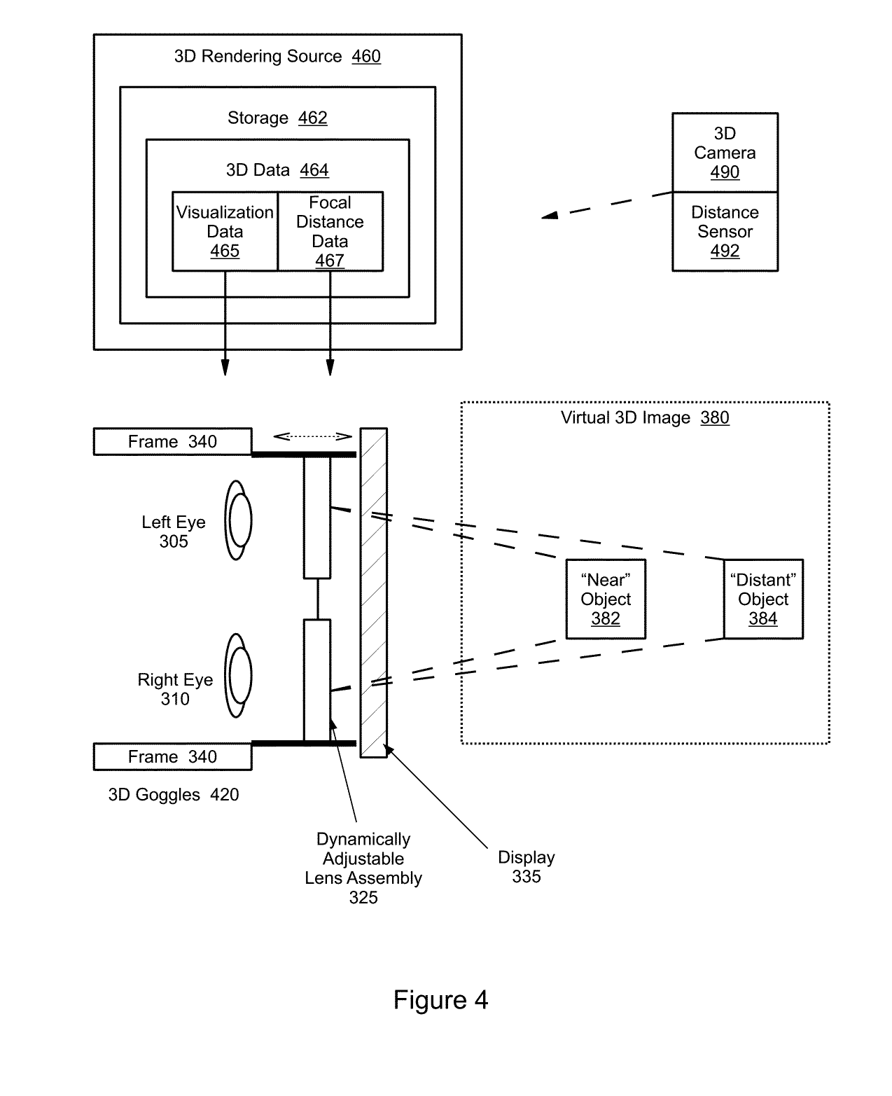

FIG. 4 illustrates an embodiment of 3D goggles with dynamically adjustable lenses utilizing data including distance data. As illustrated, 3D goggles 420 include a frame 340 and dynamically adjustable lens assembly 325 for viewing of a virtual 3D image 380 on a display 335. In some embodiments, 3D image data includes “distance to target” information (generally referred to as distance data herein). In some embodiments, a 3D rendering source 460 includes storage 462 (such as a form of computer memory or other storage) that may include 3D data 464 for display by the 3D goggles 420. In some embodiments, the 3D data 464, in addition to including 3D visualization data 465 for generating a 3D image display, includes focal distance data 467. In some embodiments, the focal distance data is data that is received with the visual data recorded synchronously with the 3D media (as in the recording of a 3D movie). For example, 3D data may be generated by the recording of a film with a 3D camera 490 in conjunction with a distance sensor 492, where the distance sensor 492 may determine a particular distance for the image at any time, such as a nominal distance for each image frame. However, embodiments are not limited to data that is generated by a 3D camera. In an example, 3D data further include computer generated video in which there is no actual distance for measurement, wherein distance data is generated based on the virtual distance of the image being generated.

In some embodiments, the goggles 420 respond dynamically to adjust to match the virtual focal distance to the apparent distance during media playback. In this illustration, as the goggle displays the visualization data 465 the dynamically adjustable lens assembly 325 responds to the focal distance data 467 to automatically adjust the focal length of the lens assembly 325 such that the adjustment is synchronized with the virtual 3D image display. In some embodiments, at a first time when the virtual 3D image 380 is displaying an image that appears to be a distant image, such as an image of distant object 384, then, according to the focal distance data 496, the lenses of the lens assembly are automatically adjusted to increase the virtual focal distance experienced by an observer of the 3D visualization. In some embodiments, at a second time when the virtual 3D image 380 is displaying an image that appears to be a near image, such as an image of near object 382, then, according to the focal distance data 496, the lenses of the assembly are automatically adjusted to decrease the virtual focal distance experienced by an observer of the 3D visualization.

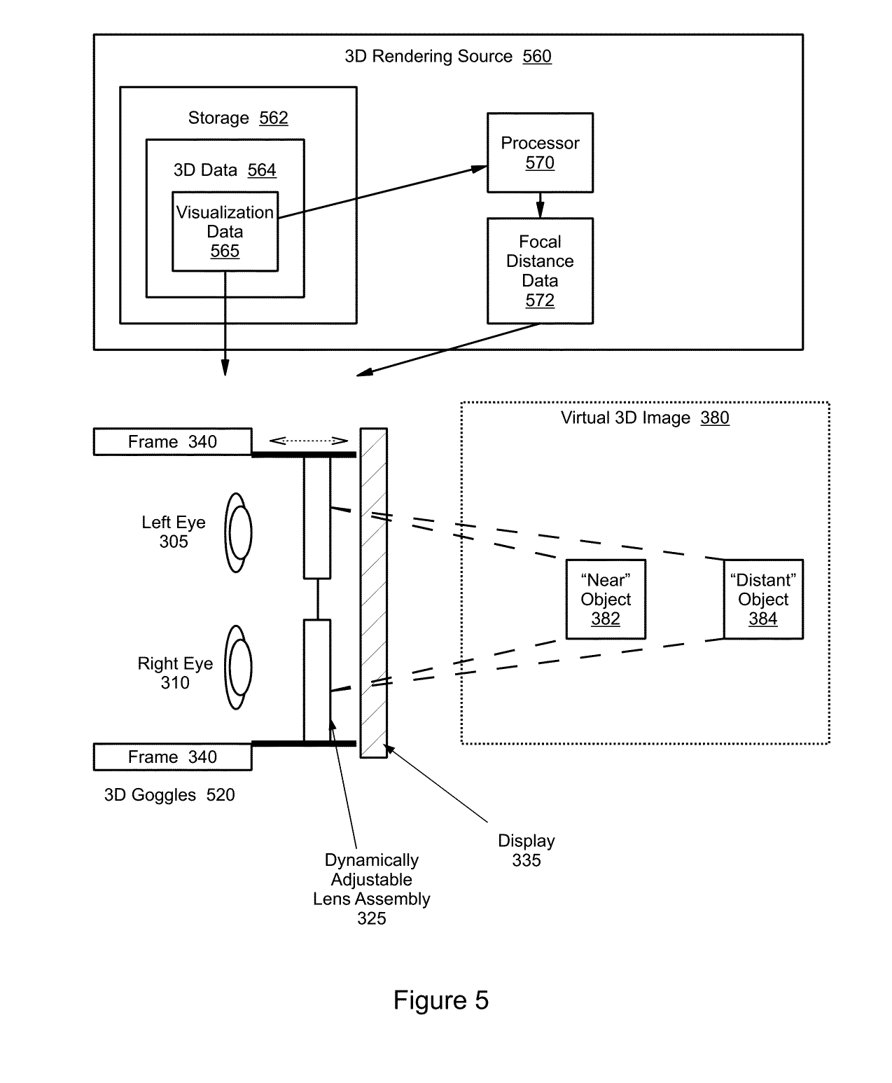

FIG. 5 illustrates an embodiment of 3D goggles with dynamically adjustable lenses utilizing calculated focal distance data. As illustrated, 3D goggles 520 with frame 340 and dynamically adjustable lens assembly 325 provide for viewing of a virtual 3D image 380 using a display 335. In some embodiments, a data source such as 3D rendering source 560 including a storage 562 to store 3D data 564, where the 3D data includes visualization data 565 for presentation of the 3D display by the 3D goggles 520. In some embodiments, the 3D rendering source 560 provides data in a matter that is applicable to virtual reality environments as well as fixed 3D media.

In some embodiments, the 3D rendering source 560 is to continuously calculate an apparent distance of a current image for a viewer. In some embodiments, the 3D rendering source 560 may include a processor or other element operable to receive the 3D data 565, analyze the 3D data to generate focal distance data 572 providing the virtual focal distances between the viewer and virtual 3D image 380. Embodiments may vary based on the specific distance that is chosen. In some embodiments, a generated virtual focal distance may be an apparent distance to an object in the virtual image 380, such as an object in the center point of the current image. For example, in FIG. 5 a virtual focal distance may be the apparent distance to near object 382 at a first time and an apparent distance to distant object 384 at a second time. In some embodiments, a generated virtual focal distance may be average object distance over the visual field. In some embodiments, a mixture of calculations may be used, such as calculating a virtual focal distance as the center of the image when there is a single primary object that is located in the center of the image and calculating a virtual focal distance as an average when there is not a single primary object or the single primary object does not remain at the center of the image.

In some embodiments, the focal length of the adjustable lenses 325 is adjusted according to the generated distance data to yield a virtual focal distance that corresponds to the apparent distance for the viewer. Such operation may be particularly helpful in cases in which the calculated focal distance is based on a center of the image and a viewer is viewing the center of the image. The typical frequency response of the human eye is approximately 3-10 Hertz, and thus the focal length adjustment may operate with a corresponding frequency response using existing automatic focusing element technologies to match or exceed the frequency response of human eye focusing.

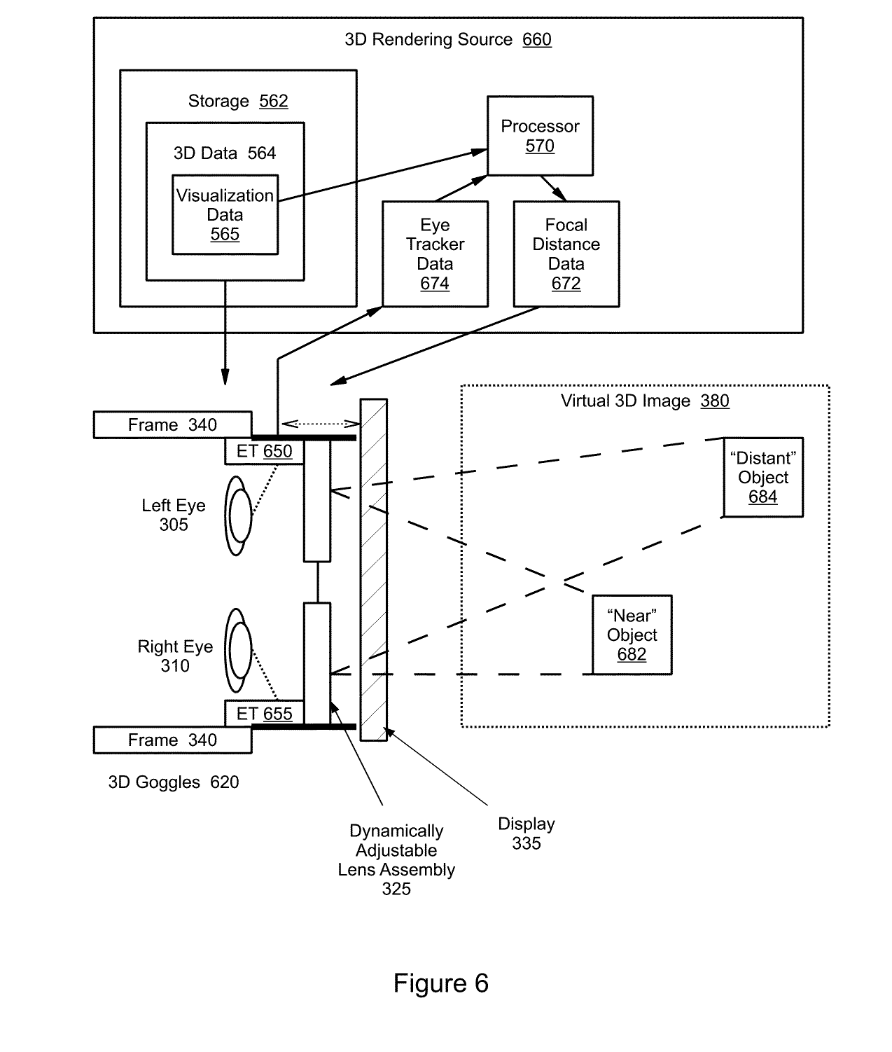

FIG. 6 illustrates an embodiment of 3D goggles with dynamically adjustable lenses utilizing calculated focal distance data and eye tracking operation. As illustrated, 3D goggles 620 with frame 340 and dynamically adjustable lens assembly 325 provide for viewing of a virtual 3D image 380 using a display 335. In some embodiments, a 3D rendering source 660 may include a storage 562 to store 3D data 564, where the 3D data includes visualization data 565 for display by the 3D goggles 620. In some embodiments, the 3D rendering source 660 provides data in a manner that is applicable to virtual reality environments as well as fixed 3D media.

In some embodiments, in order to improve implementation of focal distance determination and lens focusing, the 3D goggles 620 integrate eye-tracking technology in order to track the viewer's direction of gaze. In some embodiments, the goggles 620 include one or more eye tracker devices that are to determine a point of gaze (where the viewer is looking). Eye tracking is the process of measuring either the point of gaze (where a viewer is looking) or the motion of an eye relative to the head. An eye tracker device, also referred to as an eye tracker, is a device for measuring eye positions and eye movement. As illustrated in FIG. 6, the 3D goggles 620 may include a first eye tracker device 650 to track a position of a first eye of the viewer, the left eye 305 in this illustration. As illustrated, the 3D goggles 620 may further include a second eye tracker device 655 to track a position of a second eye of the viewer, the right eye 310 in this illustration. Embodiments may vary based on the number and placement of eye tracker devices. For the purposes of this explanation, the illustrated embodiments is discusses as having two eye tracker devices, with one eye tracker device tracking the position of each eye. While the drawing is a two-dimensional drawing that only illustrates movement left and right, the eye tracker devices are operable to track movement of the eyes of the viewer up and down as well as left and right.

In some embodiments, a 3D rendering source 660 may include a storage 562 to store 3D data 564, where the 3D data includes visualization data 565 for display by the 3D goggles 620. In some embodiments, the 3D goggles provide data generated by the eye tracker devices 650-655 for use in generation of focal distance data for the adjustment of lenses 325. In some embodiments, eye tracker data 674 generated by the eye tracker devices 650-655 is received by processor 570 of the 3D rendering source 660 together with the visualization data 565.

In some embodiments, the 3D rendering source 660 is to continuously calculate a virtual focal distance for a current image that is being viewed by the viewer based upon the direction of gaze of the viewer towards a particular location of the virtual 3D image 380 shown on the display 335. In some embodiments, the 3D rendering source 660 may include a processor or other element 570 operable to receive the 3D data 565 and the eye tracker data 674, analyze the 3D data eye tracker data to generate focal distance data 572 providing the virtual focal distances between the viewer and virtual 3D image 380 corresponding to the apparent distance for the portion of the image 380 at which the viewer is viewing. In some embodiments, the focal length of the lens assembly 324 is adjusted according to the generated focal distance to yield a focal distance from the viewer's eye to the virtual image plane that corresponds to the apparent distance seen by the viewer.

For example, in FIG. 6 it may be assumed that a near object 682 and a distant object 684 are present in the image 380 at the same time, the near object 682 appearing to the viewer to be closer to the viewer than the far object 684. In some embodiments, the eye tracker devices may determine in a first example that the viewer is viewing the near object 684. In some embodiments, the eye tracker data 674, which indicates the current direction of gaze, and the visualization data, which indicates the objects that are currently in the image 380, are processed to determine the apparent focal distance of the currently viewed object, near object 682, and produce focal distance data representing such apparent distance for goggles 620. In some embodiments, the calculation by the processor is performed based on the calculated distance to the object that the viewer is currently looking at, in contrast with, as described with regard to FIG. 5, a calculation based on a center point or an average focal distance. In an implementation, the eye tracking performed by the eye tracker devices 650-655 is performed at least as fast as the lens focal length adjustment, which may be in the range of 3-10 Hz or faster in order to match or exceed the frequency response of human eye focusing.

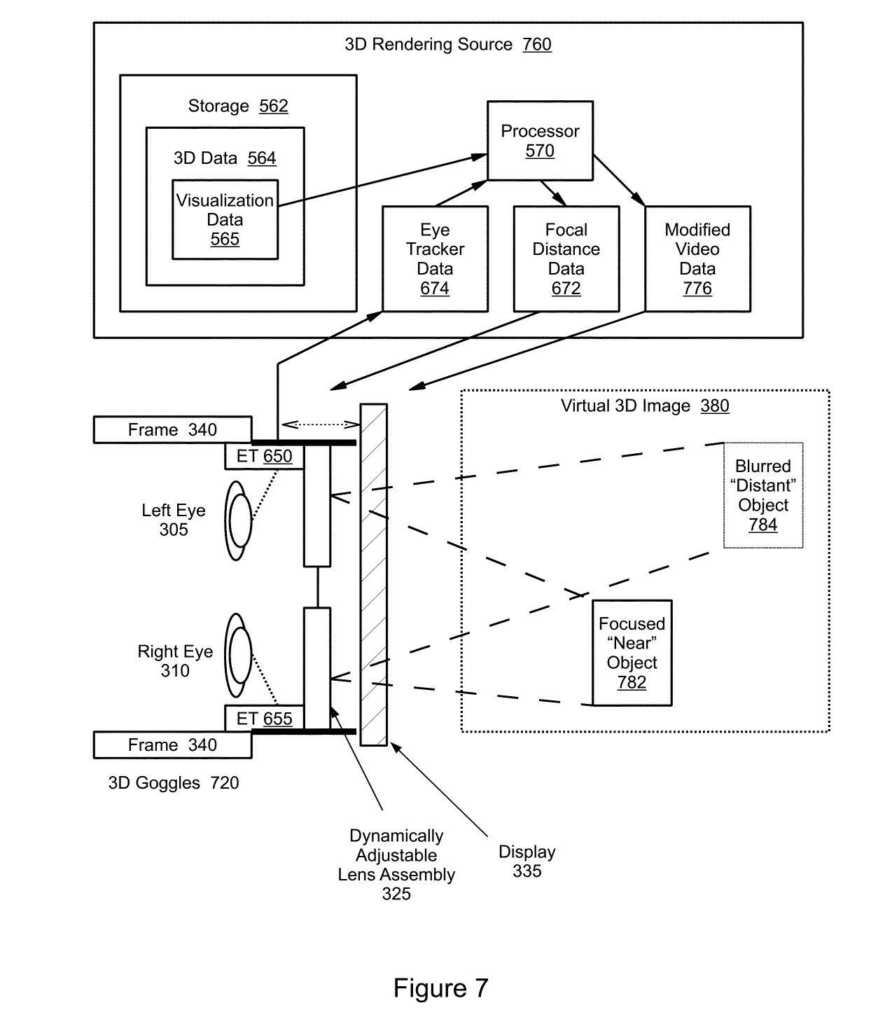

FIG. 7 illustrates an embodiment of 3D goggles with dynamically adjustable lenses utilizing calculated focal distance data and eye tracking operation and modified visualization data. As illustrated, 3D goggles 720 with frame 340 and dynamically adjustable lens assembly 325 provide for viewing of a virtual 3D image 380 using a display 335. In some embodiments, a 3D rendering source 760 may include a storage 562 to store 3D data 564, where the 3D data includes visualization data 565 for 3D image display by the 3D goggles 720.

In some embodiments the 3D goggles 720 integrate eye-tracking technology in order to track the viewer's direction of gaze, illustrated as eye tracker devices 650 and 655. In some embodiments, a 3D rendering source 760 may include a storage 562 to store 3D data 564, where the 3D data includes visualization data 565 for display by the 3D goggles 720. In some embodiments, the 3D goggles 720 provide data generated by the eye tracker devices 650-655 for use in generation of focal distance data 672 for the adjustment of the focal length of the dynamically adjustable lens assembly 325. In some embodiments, eye tracker data 674 generated by the eye tracker devices 650-655 is received by processor 570 of the 3D rendering source 760.

As described in relation to FIG. 6, the 3D rendering source 660 is to continuously calculate a virtual distance for a current image that is being viewed by the viewer based upon the direction of gaze of the viewer towards a particular location of the virtual 3D image 380 shown on the display 335. In some embodiments, the 3D rendering source 760 may include a processor or other element 570 operable to receive the 3D data 565 and the eye tracker data 674, analyze the 3D data eye tracker data to generate focal distance data 572 providing the required virtual focal distances between the viewer and virtual 3D image 380 for the portion of the image 380 at which the viewer is viewing.

In some embodiments, the processor 570 of the 3D rendering source 760 further generates modified visualization data 776 based upon the visualization data 565 and the eye tracker data 674, wherein the modified visualization data 776 provides for blurring portions of the virtual 3D image that are not at the same focal distance as an object in the direction of gaze of the viewer. In some embodiments, if objects appear in the image 380 that are not at the same focal distance as the line of sight target object, the processor 570 blurs such objects in the image 380 to simulate a realistic focusing experience. In an implementation, the eye tracking is performed as a rate that is faster than the refresh rate (such as 60 Hz) of the image, thus allowing for the direction of gaze information to be utilized in the generation of the modified visualization data 776. Thus, the focal length is adjusted based on the virtual focal distance to a target object along the viewer's line of sight, and further the graphics output to the virtual 3D display is adjusted as well based upon the focal distance of each object in the image 380. Such operation provides result in a more realistic focal/image response experience for the view, with further reduction in eye strain and further improvement in the viewer's experience.

For example, in FIG. 7 it may be assumed that a near object 782 and a distant object 784 are present in the image 380 at the same time, the near object 782 appearing to the viewer to be closer to the viewer than the far object 784. In some embodiments, the eye tracker devices 650-655 may determine in a first example that the viewer is viewing the near object 784. In some embodiments, the eye tracker data 674, which indicates the current direction of gaze, and the visualization data 565, which indicates the objects that are currently in the image 380, are processed to determine the virtual focal distance of the currently viewed object, near object 784, and the virtual focal distance of unviewed objects such as distant object 784 and produce focal distance data representing such virtual focal distance for the adjustment of the lens assembly of the goggles 720. In some embodiments, the processor 570 further determines that the viewed near object 782 and the unviewed distant object are not at a same focal distance, and, in the generation of modified visualization data 776, generates data (such as a video frame and related data) that includes a focused near object 782 and a blurred distant object 784. In a second example, the viewer may shift the viewer's gaze to distant object 784, and, in response to the change in eye tracker data 674, the processor generates modified visualization data 776 that includes a focused far object 784 and a blurred near object 782.

While the elements indicated as 3D rendering sources in FIGS. 4-7, 460 in FIG. 4, 560 in FIG. 5, 660 in FIG. 6, and 760 in FIG. 7, are depicted as a single apparatus in each such figure for ease of illustration, such elements are not limited to a single apparatus and may be contained in one or more apparatuses.

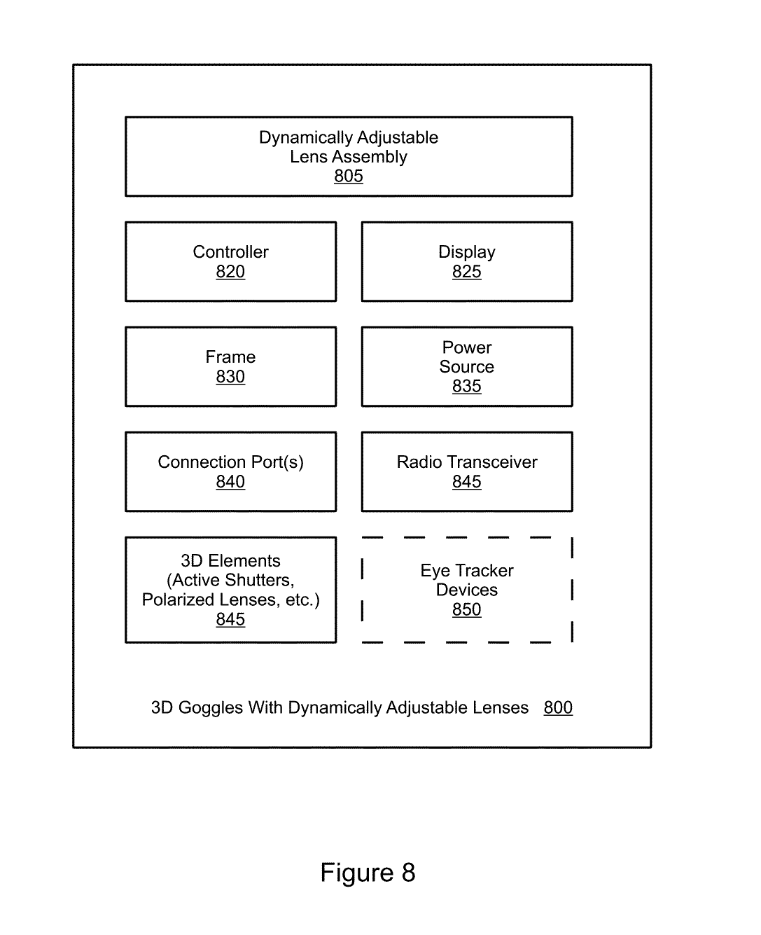

FIG. 8 is an illustration of components of 3D goggles according to an embodiment. In some embodiments, 3D goggles 800 include a dynamically adjustable focusing element 805, which include lenses for 3D operation, with an adjustable focal length. In some embodiments, the adjustable focusing element 805 includes a mechanical element to provide force for adjusting the focal length of the adjustable focusing element, such as a linear motor, rotational motor, or other mechanical element.

In some embodiments, the goggles 800 include a controller 820 to control elements of the goggles; a display 825 to display a virtual 3D image 825; a frame 830 to hold and contain elements of the goggles 800; a power source 835, such as a battery or power connection, to power the operation of the goggles 800; one or more connection ports 840 to connect any necessary cabling; a radio transceiver for transmitting and receiving data wirelessly; 3D elements 845 that are utilized to assist in generating a 3D image by providing a different image to each eye of the viewer, including, for example, active shutters for each lens, polarized lenses, or other 3D technology. In some embodiments, the goggles may optionally include eye tracker devices 850 to track movement of the eyes of a viewer and to generate eye tracking data, such as illustrated in FIGS. 6 and 7.

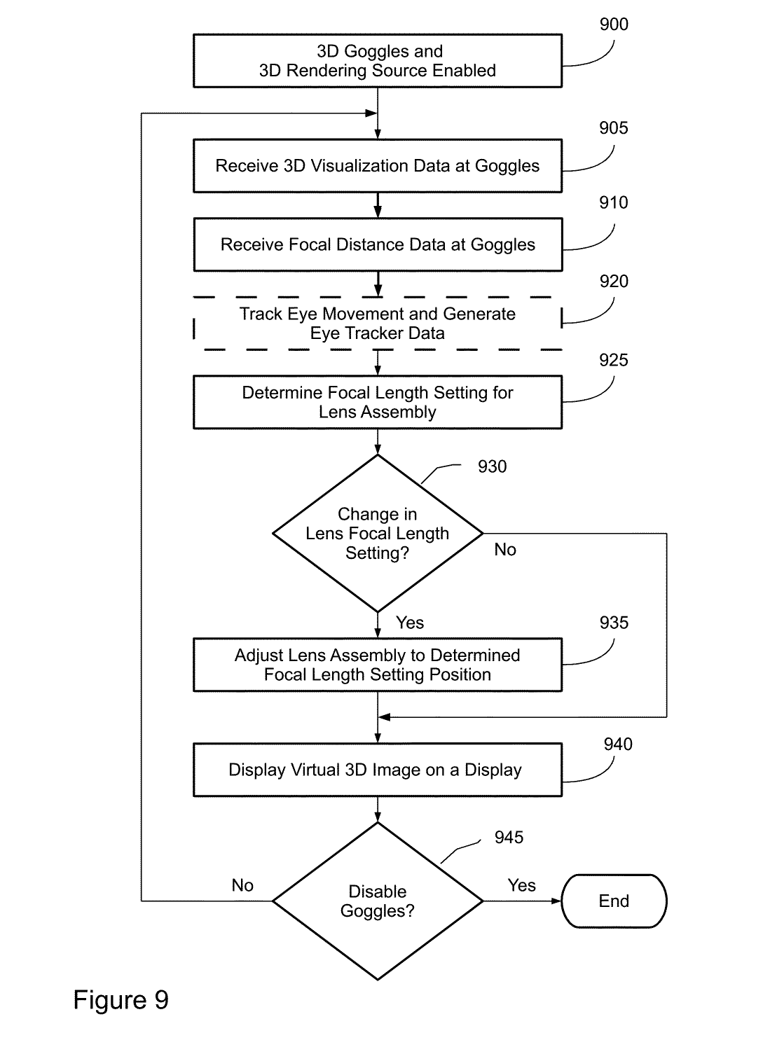

FIG. 9 is a flow chart to illustrate an embodiment of a process for 3D goggle operation. While the process is illustrated as including a number of actions, such actions may occur simultaneously at least in part, and may occur in varying orders. In some embodiments, upon a set of 3D goggles being enabled along with enablement of a 3D rendering source 900, the goggles receive 3D visualization data 905 and focal distance data 910, such as illustrated in FIGS. 3-7.

In some embodiments, the goggles may optionally provide for tracking of eye movement and generating eye tracker data 920, such as illustrated in FIGS. 6 and 7. In some embodiments, the 3D visualization data depends in part on the eye tracker data, such as the generation of modified visualization data in which one or more portions of an image that are not viewed by the viewer and that are at a different apparent distance are to be blurred, such as illustrated in FIG. 7.

In some embodiments, a focal length setting for the lens assembly is determined 925, and, if the focal distance data indicates a change in a lens focal length setting from a current setting 930, the lens assembly of the 3D goggles is to change to a new focal length setting position 935. In some embodiments, the goggles operate to display a virtual 3D image on a display 940, such as illustrated in FIGS. 3-7. Until the goggles are disabled 940 the process may continue with reception of 3D visualization data and focal distance data 905-910.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B”, element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

In some embodiments, an apparatus, wherein the apparatus may be three-dimensional (3D) goggles, includes: a frame; a display for 3D images; and a dynamically adjustable lens assembly including one or more lenses for viewing the 3D images. In some embodiments, a focal length of the lens assembly is dynamically adjustable in response to received focal distance data.

In some embodiments, the focal distance data relates to 3D visualization data that is received by the apparatus.

In some embodiments, the focal distance data is data generated during a recording of the 3D visualization data.

In some embodiments, the focal distance data is data generated based on analysis of the 3D visualization data.

In some embodiments, the apparatus further includes one or more eye tracker devices, the one or more eye tracker devices to track one or both eyes of a viewer and to generate eye tracker data representing a direction of gaze of the viewer.

In some embodiments, the focal distance data is based at least in part on the eye tracker data.

In some embodiments, the 3D visualization data is to be modified based at least in part on the eye tracker data.

In some embodiments, one or more portions of a video image that are not in a direction of gaze of the viewer and that have a different focal distance than a portion of the video image in the direction of gaze are to be blurred.

In some embodiments, the lens assembly includes a mechanical element to automatically adjust the focal length of the lens assembly.

In some embodiments, the mechanical element is one of a linear motor or a rotational motor.

In some embodiments, a method for displaying 3D images includes: receiving 3D visualization data from a data source at 3D goggles; receiving focal distance data at the 3D goggles; determining a focal length setting of a lens assembly of the 3D goggles based on the received focal distance data; and, upon determining that a current focal length setting of the lens assembly does not match the determined focal length setting, then automatically adjusting the lens assembly to the new focal length setting.

In some embodiments, the further includes displaying an image on a display of the 3D goggles using the received 3D visualization data.

In some embodiments, the focal distance data relates to 3D visualization data that is received by the 3D goggles.

In some embodiments, the method further includes tracking one or both eyes of a viewer and generating eye tracker data representing a direction of gaze of the viewer.

In some embodiments, the method further includes providing the eye tracker data for processing, wherein the focal distance data is based at least in part on the eye tracker data.

In some embodiments, the 3D visualization data is to be modified based at least in part on the eye tracker data.

In some embodiments, one or more portions of a video image that are not in a direction of gaze of the viewer and that have a different focal distance than a portion of the video image in the direction of gaze are to be blurred.

In some embodiments, the method further includes tracking one or both eyes of a viewer and generating eye tracker data representing a direction of gaze of the viewer and providing the eye tracker data for processing, wherein the focal distance data is based at least in part on the eye tracker data.

In some embodiments, the 3D visualization data is to be modified based at least in part on the eye tracker data, and one or more portions of a video image that are not in a direction of gaze of the viewer and have a different focal distance than a portion of the video image in the direction of gaze are to be blurred.

In some embodiments, automatically adjusting the focal length of the lens assembly includes changing a position of a motor of the lens assembly.

In some embodiments, an apparatus for displaying 3D images includes: a means for receiving 3D visualization data from a data source at 3D goggles; a means for receiving focal distance data at the 3D goggles; a means for determining a focal length setting of a lens assembly of the 3D goggles based on the received focal distance data; and a means for automatically adjusting the lens assembly to the new focal length setting upon determining that a current focal length setting of the lens assembly does not match the determined focal length setting.

In some embodiments, the apparatus further includes a means for displaying an image on a display of the 3D goggles using the received 3D visualization data.

In some embodiments, the focal distance data relates to 3D visualization data that is received by the 3D goggles.

In some embodiments, the apparatus further includes means for tracking one or both eyes of a viewer and generating eye tracker data representing a direction of gaze of the viewer.

In some embodiments, the apparatus is to provide the eye tracker data for processing, wherein the focal distance data is based at least in part on the eye tracker data.

In some embodiments, the 3D visualization data is to be modified based at least in part on the eye tracker data.

In some embodiments, one or more portions of a video image that are not in a direction of gaze of the viewer and that have a different focal distance than a portion of the video image in the direction of gaze are to be blurred.

In some embodiments, the means for automatically adjusting the focal length of the lens assembly includes a means for changing a position of a motor of the lens assembly.

In some embodiments, a system includes: goggles for display of 3D images, the goggles including a display to display the 3D images, and a dynamically adjustable lens assembly including one or more lenses for viewing the 3D images; and a data source including storage for 3D data, the data source to provide 3D visualization data and focal distance data to the goggles. In some embodiments, a focal length of the lens assembly is to be automatically adjusted in response to the focal distance data received from the data source.

In some embodiments, the focal distance data relates to the 3D visualization data provided by the data source.

In some embodiments, the data source includes a processor, the processor to analyze the 3D visualization data to generate the focal distance data.

In some embodiments, the goggles further include one or more eye tracker devices, the one or more eye tracker devices to track one or both eyes of a viewer, the goggles to generate eye tracker data representing a direction of gaze of the viewer.

In some embodiments, the generation of the focal distance data by the data source is based at least in part on the eye tracker data.

In some embodiments, the data source is to modify the 3D visualization data based at least in part on the eye tracker data.

In some embodiments, modifying the 3D visualization data by the data source includes the data source to blur one or more portions of a video image that are not in a direction of gaze of the viewer and that have a different focal distance than a portion of the video image in the direction of gaze of the viewer.

In some embodiments, a non-transitory computer-readable storage medium having stored thereon data representing sequences of instructions that, when executed by a processor, cause the processor to perform operations including: receiving 3D visualization data from a data source at 3D goggles; receiving focal distance data at the 3D goggles; determining a focal length setting of a lens assembly of the 3D goggles based on the received focal distance data; and, if a current focal length setting of the lens assembly does not match the determined focal length setting, then automatically adjusting the lens assembly to the new focal length setting.

In some embodiments, the medium further includes instructions that, when executed by the processor, cause the processor to perform operations including displaying an image on a display of the 3D goggles using the received 3D visualization data.

In some embodiments, the focal distance data relates to 3D visualization data that is received by the 3D goggles.

In some embodiments, the medium further includes instructions that, when executed by the processor, cause the processor to perform operations including tracking one or both eyes of a viewer and generating eye tracker data representing a direction of gaze of the viewer.

In some embodiments, the medium further includes instructions that, when executed by the processor, cause the processor to perform operations comprising: providing the eye tracker data for processing, wherein the focal distance data is based at least in part on the eye tracker data.

In some embodiments, the received 3D visualization data is to be modified based at least in part on the eye tracker data.

In some embodiments, one or more portions of a video image that are not in a direction of gaze of the viewer and that have a different focal distance than a portion of the video image in the direction of gaze are to be blurred.

In some embodiments, automatically adjusting the focal length of the lens assembly includes changing a position of a motor of the lens assembly.

What is claimed is:

1. An apparatus comprising:
a frame;
a display for three-dimensional (3D) images; and
a dynamically adjustable lens assembly including one or more lenses for viewing the 3D images;
wherein a focal length of the lens assembly is dynamically adjustable in response to received focal distance data.

2. The apparatus of claim 1, wherein the focal distance data relates to 3D visualization data that is received by the apparatus.

3. The apparatus of claim 2, wherein the focal distance data is data generated during a recording of the 3D visualization data.

4. The apparatus of claim 2, wherein the focal distance data is data generated based on analysis of the 3D visualization data.

5. The apparatus of claim 4, further comprising one or more eye tracker devices, the one or more eye tracker devices to track one or both eyes of a viewer and to generate eye tracker data representing a direction of gaze of the viewer.

6. The apparatus of claim 5, wherein the focal distance data is based at least in part on the eye tracker data.

7. The apparatus of claim 6, wherein the 3D visualization data is to be modified based at least in part on the eye tracker data.

8. The apparatus of claim 7, wherein one or more portions of a video image that are not in a direction of gaze of the viewer and that have a different focal distance than a portion of the video image in the direction of gaze are to be blurred.

9. The apparatus of claim 1, wherein the lens assembly includes a mechanical element to automatically adjust the focal length of the lens assembly.

10. The apparatus of claim 9, wherein the mechanical element is one of a linear motor or a rotational motor.

11. A method comprising:
receiving three-dimensional (3D) visualization data from a data source at 3D goggles;
receiving focal distance data at the 3D goggles;
determining a focal length setting of a lens assembly of the 3D goggles based on the received focal distance data; and
upon determining that a current focal length setting of the lens assembly does not match the determined focal length setting, then automatically adjusting the lens assembly to the new focal length setting.

12. The method of claim 11, further comprising displaying an image on a display of the 3D goggles using the received 3D visualization data.

13. The method of claim 11, wherein automatically adjusting the focal length of the lens assembly includes changing a position of a motor of the lens assembly.

14. A system comprising:
goggles for display of three-dimensional (3D) images, the goggles including:
a display to display the 3D images, and
a dynamically adjustable lens assembly including one or more lenses for viewing the 3D images; and
a data source including:
storage for 3D data, the data source to provide 3D visualization data and focal distance data to the goggles;
wherein a focal length of the lens assembly is to be automatically adjusted in response to the focal distance data received from the data source.

15. The system of claim 14, wherein the focal distance data relates to the 3D visualization data provided by the data source.

16. The system of claim 15, wherein the data source includes a processor, the processor to analyze the 3D visualization data to generate the focal distance data.

17. The system of claim 16, wherein the goggles further include one or more eye tracker devices, the one or more eye tracker devices to track one or both eyes of a viewer, wherein the goggles are to generate eye tracker data representing a direction of gaze of the viewer, and wherein the generation of the focal distance data by the data source is based at least in part on the eye tracker data.

18. The system of claim 17, wherein the data source is to modify the 3D visualization data based at least in part on the eye tracker data.

19. The system of claim 18, wherein modifying the 3D visualization data by the data source includes the data source to blur one or more portions of a video image that are not in a direction of gaze of the viewer and that have a different focal distance than a portion of the video image in the direction of gaze of the viewer.

20. A non-transitory computer-readable storage medium having stored thereon data representing sequences of instructions that, when executed by a processor, cause the processor to perform operations comprising:
receiving three-dimensional (3D) visualization data from a data source at 3D goggles;
receiving focal distance data at the 3D goggles;
determining a focal length setting of a lens assembly of the 3D goggles based on the received focal distance data; and
if a current focal length setting of the lens assembly does not match the determined focal length setting, then automatically adjusting the lens assembly to the new focal length setting.

21. The medium of claim 20, further comprising instructions that, when executed by the processor, cause the processor to perform operations comprising:
displaying an image on a display of the 3D goggles using the received 3D visualization data.

22. The medium of claim 20, wherein the focal distance data relates to 3D visualization data that is received by the 3D goggles.

23. The medium of claim 22, further comprising instructions that, when executed by the processor, cause the processor to perform operations comprising:
tracking one or both eyes of a viewer using one or more eye tracker devices and generating eye tracker data representing a direction of gaze of the viewer; and
providing the eye tracker data for processing, wherein the focal distance data is based at least in part on the eye tracker data.

24. The medium of claim 23, wherein the received 3D visualization data is to be modified based at least in part on the eye tracker data.

25. The medium of claim 24, wherein one or more portions of a video image that are not in a direction of gaze of the viewer and that have a different focal distance than a portion of the video image in the direction of gaze are to be blurred.
